(19) United States
(12) Patent Application Publication
(10) Pub. No.: US 2024/0386110 A1
(43) Pub. Date: Nov. 21, 2024

(54) BACKDOOR DETECTION DEVICE, BACKDOOR DETECTION METHOD, AND RECORDING MEDIUM

(71) Applicant: NEC Corporation, Minato-ku, Tokyo (JP)

(72) Inventor: Kohei TATARA, Tokyo (JP)

(73) Assignee: NEC Corporation, Minato-ku, Tokyo (JP)

(21) Appl. No.: 18/694,058

(22) PCT Filed: Oct. 27, 2021
(86) PCT No.: PCT/JP2021/039605

§ 371 Date: Mar. 21, 2024

(51) Int. Cl. G06F 21/56

(52) U.S. Cl. CPC G06F 21/566

(57) ABSTRACT

A backdoor detection device according to the present disclosure is equipped with: a normal flow acquisition means that executes, in a test environment, firmware of a device to be monitored, and acquires normal input/output flow information including an input/output flow related to an observed input/output; an operation flow acquisition means that executes the firmware in an actual operating environment, and acquires operation input/output flow information including an input/output flow relating to an observed input/output; a backdoor determination means that determines whether a backdoor is present on the basis of a comparison between the acquired normal input/output flow information and the operation input/output flow information; and an output means that outputs the result of the determination by the backdoor determination means.

### TECHNICAL FIELD

The present disclosure relates to a backdoor detection device, a backdoor detection method, and a recording medium.

### BACKGROUND ART

As one countermeasure against supply chain and risks when a device is procured from the outside, there is a technology for detecting an unauthorized function in a program, such as a backdoor.

For example, PTL 1 discloses an abnormality detection device that compares a normal calling relationship between functions until a specific function as a monitoring target is called by an application program with a calling relationship between functions until the specific function is called by the application program in response to an event of calling the specific function as the monitoring target. When the calling relationships do not coincide with each other as a result of comparing the above relationships, the abnormality detection device detects a function calling operation associated with the event as an abnormal operation.

### CITATION LIST

### Patent Literature

PTL 1: JP 2011-258019 A

### SUMMARY OF INVENTION

### Technical Problem

However, in an unauthorized access using a backdoor, an input/output flow that significantly affects the system is executed with information known only by an attacker as a trigger in many cases. In the invention disclosed in PTL 1 described above, there is a probability of an unauthorized function through a backdoor being included in the normal calling relationship.

An example of an object of the present disclosure is to provide a backdoor detection device capable of increasing a detection rate of a backdoor.

### Solution to Problem

A backdoor detection device in an aspect of the present disclosure includes regular flow acquisition means that acquires regular input/output flow information including an input/output flow associated with an input/output observed by executing firmware of a device that is a monitoring target under a test environment, operation flow acquisition means that acquires operation input/output flow information including an input/output flow associated with an input/output observed by executing the firmware under an actual operation environment, backdoor determination means that determines whether a backdoor exists based on a comparison between the acquired regular input/output flow information and the acquired operation input/output flow information, and output means that outputs a result of the determination by the backdoor determination means.

A backdoor detection method in another aspect of the present disclosure includes acquiring regular input/output flow information including an input/output flow associated with an input/output observed by executing firmware of a device that is a monitoring target under a test environment, acquiring operation input/output flow information including an input/output flow associated with an input/output observed by executing the firmware under an actual operation environment, determining whether a backdoor exists based on a comparison between the acquired regular input/output flow information and the acquired operation input/output flow information, and outputting a result of the determination.

A recording medium in still another aspect of the present disclosure stores a program for causing a computer to perform acquiring regular input/output flow information including an input/output flow associated with an input/output observed by executing firmware of a device that is a monitoring target under a test environment, acquiring operation input/output flow information including an input/output flow associated with an input/output observed by executing the firmware under an actual operation environment, determining whether a backdoor exists based on a comparison between the acquired regular input/output flow information and the acquired operation input/output flow information, and outputting a result of the determination.

### Advantageous Effects of Invention

As an example of an effect according to the present disclosure, it is possible to provide a backdoor detection device capable of increasing a detection rate of a backdoor.

### BRIEF DESCRIPTION OF DRAWINGS

FIG. 1 is a block diagram illustrating a configuration of a backdoor detection device in a first example embodiment.

FIG. 2 is a diagram illustrating a hardware configuration in which the backdoor detection device in the first example embodiment is achieved by a computer device and peripheral devices of the computer device.

FIG. 3 is a diagram for describing regular input/output flow information in the first example embodiment.

FIG. 4 is a diagram for describing operation input/output flow information in the first example embodiment.

FIG. 5 is a flowchart illustrating backdoor detection in the first example embodiment.

FIG. 6 is a block diagram illustrating a configuration of a backdoor detection device in a second example embodiment.

FIG. 7 is a flowchart illustrating an operation of backdoor detection in the second example embodiment.

### EXAMPLE EMBODIMENTS

Hereinafter, example embodiments will be described in detail with reference to the drawings.

### First Example Embodiment

A backdoor detection device 100 in a first example embodiment is a device that detects whether an unauthorized function such as a backdoor is included in firmware of a provided device when the device provided from an external business operator is incorporated in the own system, for example.

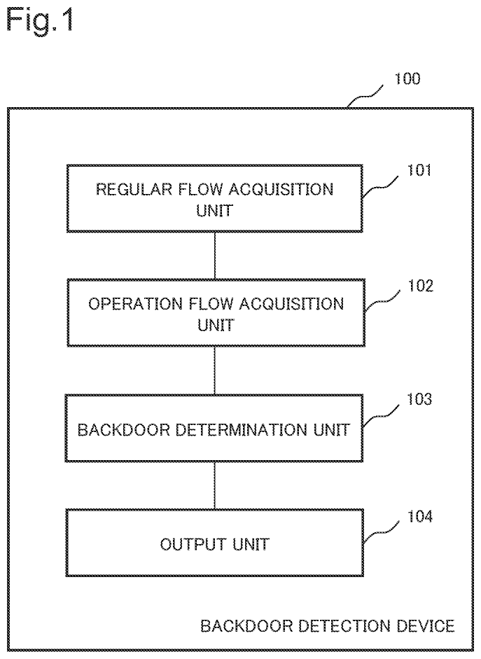

FIG. 1 is a block diagram illustrating a configuration of the backdoor detection device 100 in the first example embodiment. Referring to FIG. 1, the backdoor detection device 100 includes a regular flow acquisition unit 101, an operation flow acquisition unit 102, a backdoor determination unit 103, and an output unit 104. The backdoor detection device 100 which is an essential configuration of the present example embodiment will be described below in detail.

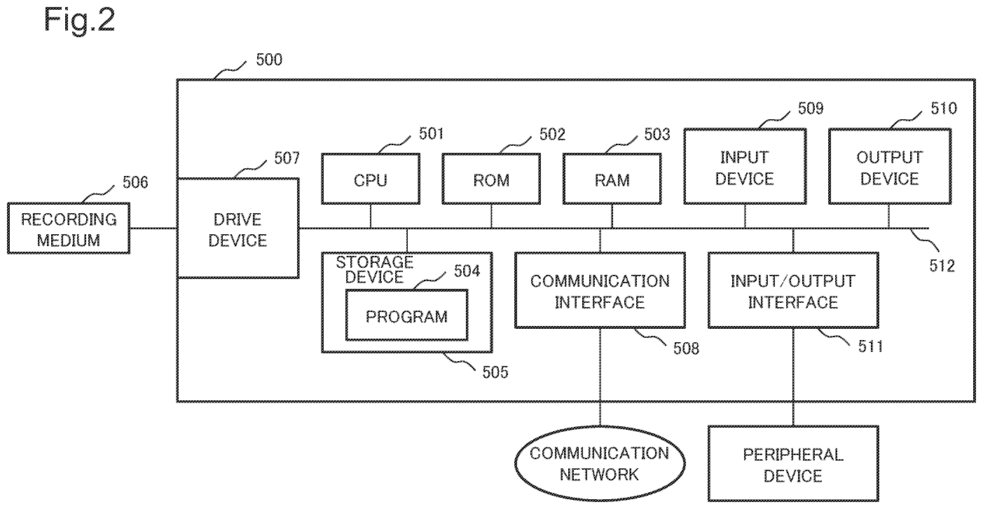

FIG. 2 is a diagram illustrating an example of a hardware configuration in which the backdoor detection device 100 in the first example embodiment of the present disclosure is achieved by a computer device 500 including a processor. As illustrated in FIG. 2, the backdoor detection device 100 includes a central processing unit (CPU) 501, a memory such as a read only memory (ROM) 502 and a random access memory (RAM) 503, a storage device 505 such as a hard disk that stores a program 504, a communication interface (I/F) 508 for network connection, and an input/output interface 511 that inputs and outputs data. In the first example embodiment, the input/output flow information of the firmware acquired by the regular flow acquisition unit 101 and the operation flow acquisition unit 102 is input to the backdoor detection device 100 via an input/output interface 511.

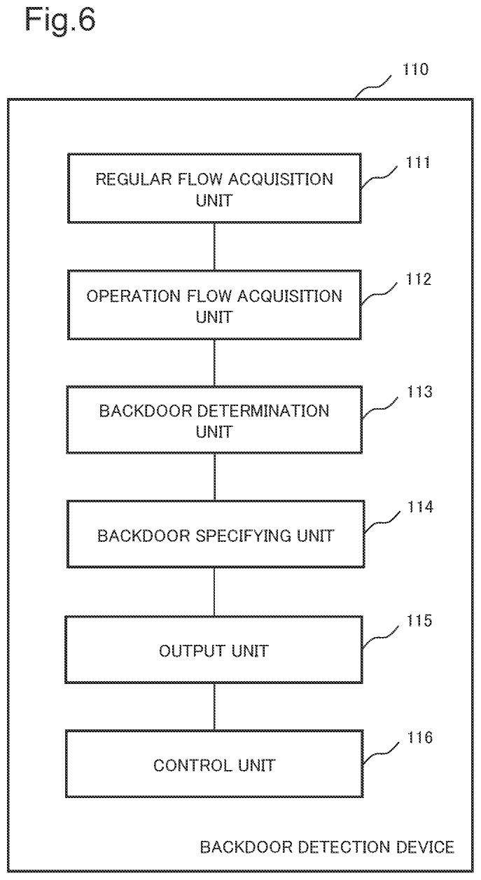

The CPU 501 controls the entirety of the backdoor detection device 100 according to the first example embodiment of the present invention by operating an operating system. The CPU 501 reads a program and data from a recording medium 506 mounted on, for example, a drive device 507 to the memory. The CPU 501 functions as the regular flow acquisition unit 101, the operation flow acquisition unit 102, the backdoor determination unit 103, the output unit 104, and parts of the above units in the first example embodiment, and executes processes or commands in the flowchart illustrated in FIG. 6 to be described later based on the program.

The recording medium 506 is, for example, an optical disc, a flexible disk, a magnetic optical disc, an external hard disk, a semiconductor memory, or the like. Some recording media of the storage device are non-volatile storage devices, and record programs therein. The program may be downloaded from an external computer (not illustrated) connected to a communication network.

The input device 509 is achieved by, for example, a mouse, a keyboard, a built-in key button, and the like, and is used for an input operation. The input device 509 is not limited to the mouse, the keyboard, and the built-in key button, and may be, for example, a touch panel. The output device 510 is achieved by, for example, a display, and is used to confirm an output.

As described above, the first example embodiment illustrated in FIG. 1 is achieved by computer hardware illustrated in FIG. 2. Means for achieving each unit provided in the backdoor detection device 100 of FIG. 1 is not limited to the above-described configuration. The backdoor detection device 100 may be achieved by one physically coupled device, or may be achieved by a plurality of devices by connecting two or more physically separated devices in a wired or wireless manner. For example, the input device 509 and the output device 510 may be connected to the computer device 500 via a network. The backdoor detection device 100 in the first example embodiment illustrated in FIG. 1 may be configured by cloud computing or the like.

In FIG. 1, the regular flow acquisition unit 101 is means that acquires regular input/output flow information including an input/output flow associated with an input/output observed by executing firmware of a device that is a monitoring target under a test environment. The regular input/output flow information is information of an input/output flow assumed to be associated with a regular operation of the firmware without intervention from an attacker. The test environment is an environment in which a function of the firmware is tested before an operation after delivery of the device. In the present example embodiment, the test environment is, for example, an environment that is blocked from an external network and in which an input from the outside does not intervene. For example, the regular flow acquisition unit 101 executes the firmware only at a portion including a flow associated with the input/output of data. The input/output flow associated with the input/output is a flow associated with the input/output of data among flows executed by the firmware. The regular flow acquisition unit 101 monitors activation of the firmware under the test environment. For example, when detecting the activation of the firmware, the regular flow acquisition unit 101 acquires input/output flow information observed during execution of the firmware. The input/output flow information can be acquired by software or the like that performs conventional program analysis.

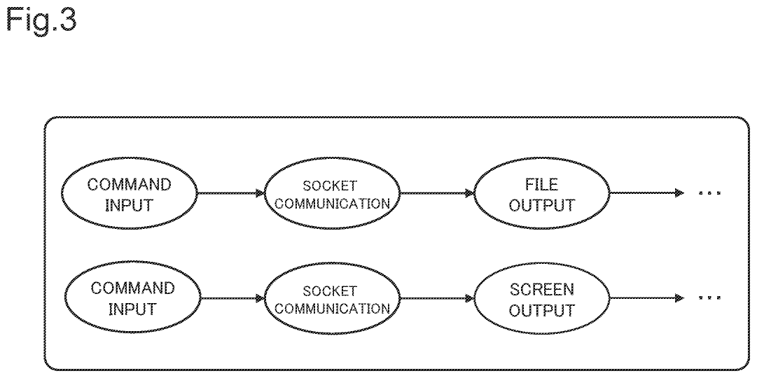

FIG. 3 is a diagram for describing the regular input/output flow information in the first example embodiment. In the example of FIG. 3, an input/output flow “command input→socket communication→file output” and an input/output flow “command input→socket communication→screen output” are observed. The regular flow acquisition unit 101 outputs the observed input/output flow information to the backdoor determination unit 103. The regular flow acquisition unit 101 may acquire a file including the regular input/output flow information created by another business operator, and output the file to the backdoor determination unit 103.

The operation flow acquisition unit 102 is means that acquires operation input/output flow information including an input/output flow associated with an input/output observed by executing firmware of a device that is a monitoring target under an actual operation environment. The operation input/output flow information is information of an input/output flow that has a probability of intervention from an attacker and may include a flow associated with a backdoor. The actual operation environment is an environment in which a device is incorporated in an actual system. In the present example embodiment, the actual operation environment is, for example, an environment in which communication with an external network is possible, an input from the outside may intervene, and an input from an attacker may intervene. Specifically, for example, the actual operation environment is an environment in which data can be output to an external server or writing to external data is possible. The operation flow acquisition unit 102 executes the firmware only at a portion including a flow associated with the input/output of data. The operation flow acquisition unit 102 monitors activation of the firmware under the actual operation environment. For example, when detecting the activation of the firmware, the operation flow acquisition unit 102 acquires input/output flow information observed during execution of the firmware. The input/output flow information can be acquired by software or the like that performs conventional program analysis.

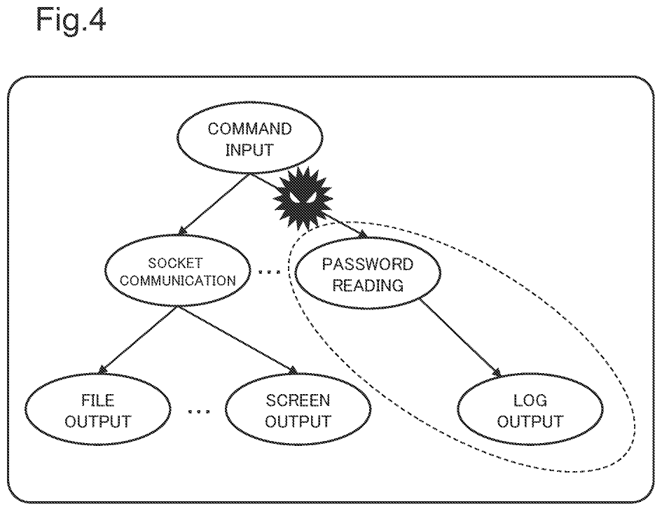

FIG. 4 is a diagram for describing the operation input/output flow information in the first example embodiment. In the example of FIG. 4, an input/output flow “password reading→log output”, which has not been observed in the test environment, is observed in addition to the input/output flow “command input→socket communication→file output” and the input/output flow “command input→socket communication→screen output”. The operation flow acquisition unit 102 outputs the operation input/output flow information acquired in this manner to the backdoor determination unit 103.

The backdoor determination unit 103 is means that determines whether a backdoor exists based on a comparison between the acquired regular input/output flow information and the operation input/output flow information. When the regular input/output flow information is input from the regular flow acquisition unit 101 and the operation input/output flow information is input from the operation flow acquisition unit 102, the backdoor determination unit 103 compares the input/output flows with each other. If the input/output flow that is not included in the regular input/output flow information exists in the operation input/output flow information, the backdoor determination unit 103 determines that a backdoor exists. In the example of FIG. 4, since the input/output flow “password reading→log output” which is not included in the regular input/output flow information exists in the operation input/output flow information, the backdoor determination unit 103 determines that the backdoor exists.

If a predetermined number or more of input/output flows that are not included in the regular input/output flow information exist in the operation input/output flow information, the backdoor determination unit 103 may determine that a backdoor exists. The predetermined value or more is a case where a plurality of (for example, two) input/output flows different from the regular input/output flow are included in the operation input/output flow information. The backdoor determination unit 103 may determine that a backdoor exists if there is even one different input/output flow as long as the input/output is related to data with high confidentiality.

The output unit 104 is means that outputs a result evaluated by the backdoor determination unit 103. When the backdoor determination unit 103 determines that the backdoor exists, the output unit 104 outputs an alert signal. The output unit 104 may display the alert by the output device 510 of the backdoor detection device 100 or may present the alert signal by voice.

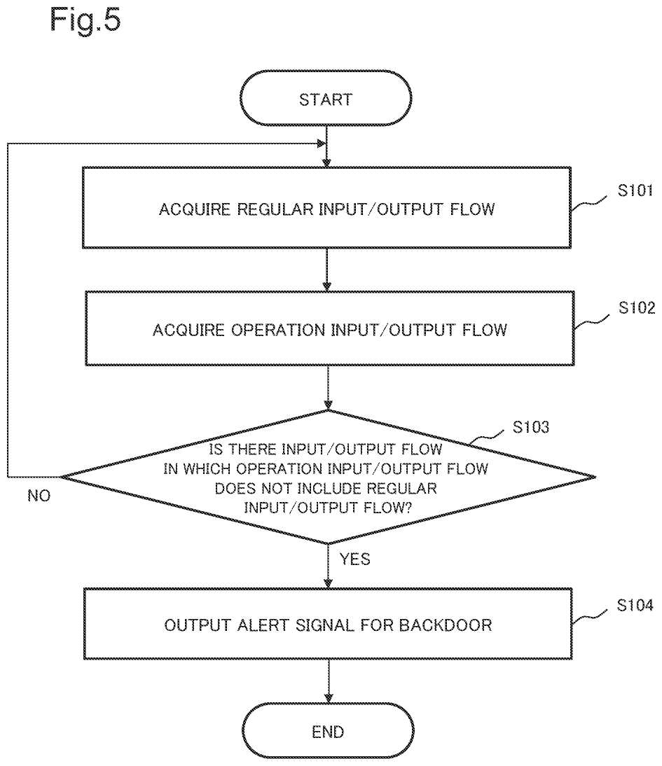

The operation of the backdoor detection device 100 configured as described above will be described with reference to the flowchart of FIG. 5.

FIG. 5 is a flowchart illustrating an outline of the operation of the backdoor detection device 100 in the first example embodiment. Processes according to this flowchart may be executed based on program control by the processor described above.

As illustrated in FIG. 5, first, the regular flow acquisition unit 101 acquires the regular input/output flow information observed by executing the firmware under the test environment (Step S101). Then, the operation flow acquisition unit 102 acquires the operation input/output flow information observed by executing the firmware under the actual operation environment (Step S102). Then, if the acquired operation input/output flow information includes an input/output flow that is not included in the regular input/output flow information, it is determined that a backdoor exists (Step S103; YES). On the other hand, if the acquired operation input/output flow information includes no input/output flow that is not included in the regular input/output flow information, the backdoor determination unit 103 determines that no backdoor exists (Step S103; NO), and a series of flows is repeated at predetermined intervals. Finally, if the backdoor determination unit 103 determines that the backdoor exists, the output unit 104 outputs an alert signal (Step S104). Thus, the backdoor detection device 100 ends the operation of the backdoor detection.

In the backdoor detection device 100 according to the present example embodiment, the backdoor determination unit 103 determines whether a backdoor exists based on a comparison between the acquired regular input/output flow information and the operation input/output flow information. The regular input/output flow information acquired by the regular flow acquisition unit 101 in the present example embodiment is flow information observed under the test environment in which an input from the outside does not intervene. The operation input/output flow information acquired by the operation flow acquisition unit 102 is means observed under the actual environment in which an input from the outside intervenes. As a result, by comparing the regular input/output flow information with the operation input/output flow information, for example, it is possible to detect the backdoor triggered by the input from the outside, which is known only by the attacker and is included in the operation input/output flow information. As a result, it is possible to increase the detection rate of the backdoor.

### Second Example Embodiment

Next, a second example embodiment of the present disclosure will be described in detail with reference to the drawings. Description of contents overlapping with the above description will be omitted in a range in which the description of the present example embodiment is not made unclear. Similarly to the computer device illustrated in FIG. 2, a function of each component in each example embodiment of the present disclosure can be achieved not only by hardware but also by a computer device or firmware based on program control.

FIG. 6 is a block diagram illustrating a configuration of a backdoor detection device 110 according to the second example embodiment of the present disclosure. Referring to FIG. 6, the backdoor detection device 110 according to the second example embodiment will be described focusing on a part different from the backdoor detection device 100 according to the first example embodiment. The backdoor detection device 110 according to the second example embodiment includes a regular flow acquisition unit 111, an operation flow acquisition unit 112, a backdoor determination unit 113, a backdoor specifying unit 114, an output unit 115, and a control unit 116. The configurations and functions of the regular flow acquisition unit 111, the operation flow acquisition unit 112, and the backdoor determination unit 113 in the present example embodiment are similar to those of the regular flow acquisition unit 101, the operation flow acquisition unit 102, and the backdoor determination unit 103 in the first example embodiment, and thus will be omitted here.

When the backdoor determination unit 113 determines that a backdoor exists, the backdoor specifying unit 114 specifies an input/output flow determined to be the backdoor. The backdoor specifying unit 114 compares the regular input/output flow information with the operation input/output flow information, and specifies, as a backdoor, an input/output flow that is not included in the regular input/output flow information among the input/output flows included in the operation input/output flow information.

Returning to FIG. 4, the input/output flow specified as the backdoor in the second example embodiment will be described. In the example of FIG. 4, when the regular input/output flow information is compared with the operation input/output flow information, one input/output flow “password reading→log output” of flows branched at “command input” does not exist in the regular input/output flow information. As a result, the backdoor determination unit 113 specifies the input/output flow “password reading→log output” as the input/output flow including the backdoor. The input/output flow “password reading→log output” outputs a read log of a password file, and is an input/output flow that significantly affects the system in terms of information leakage. Another example of the input/output flow including the backdoor includes an unauthorized intrusion into the system such as “input of information known only by an attacker (socket communication)→promotion of authority→execution of shell program”. In this input/output flow, the promotion of the authority and the execution of the shell program can be detected by observing a program execution screen. The backdoor specifying unit 114 outputs the specified input/output flow information to the output unit 115 and the control unit 116.

The output unit 115 outputs the input/output flow information specified by the backdoor specifying unit 114 to the output device 510 and the like together with the alert.

The control unit 116 performs control in such a way as not to execute the input/output flow specified by the backdoor specifying unit 114. When the input/output flow information specified as the backdoor is input from the backdoor specifying unit 114, the control unit 116 updates the program codes in such a way as not to execute the specified input/output flow, for example.

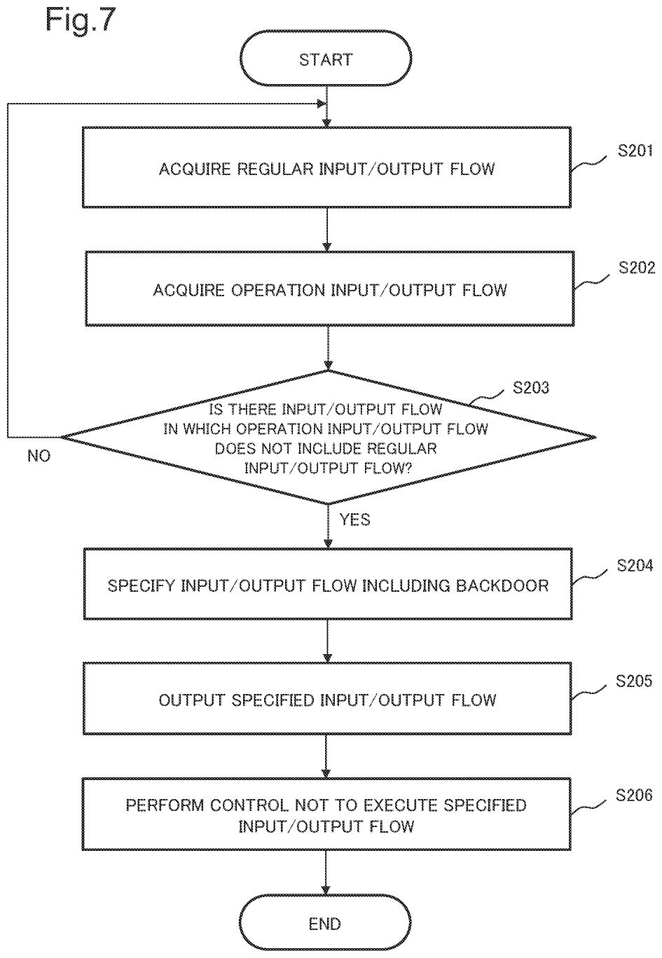

The operation of the information processing system 11 configured as described above will be described with reference to the flowchart of FIG. 7.

FIG. 7 is a flowchart illustrating an outline of the operation of the backdoor detection device 110 in the second example embodiment. Processes according to this flowchart may be executed based on program control by the processor described above. Since Steps S201 to S203 in the second example embodiment are similar to the float in Steps S101 to S103 in the first example embodiment, the description thereof will be omitted.

As illustrated in FIG. 7, when the backdoor determination unit 113 determines that a backdoor exists (Step S203; YES), the backdoor specifying unit 114 specifies an input/output flow determined to include the backdoor (Step S204). Then, the output unit 115 outputs the specified input/output flow information (Step S205). Finally, the control unit 116 performs control in such a way as not to execute the input/output flow specified by the backdoor specifying unit 114 (Step S206). Thus, the backdoor detection device 110 ends the operation of the backdoor detection.

In the second example embodiment of the present disclosure, the output unit 115 outputs the input/output flow information specified by the backdoor specifying unit 114 to the output device 510 and the like. As a result, an analyst of the firmware can analyze the location where the backdoor is incorporated in more detail. In the second example embodiment of the present disclosure, the control unit 116 performs control in such a way as not to execute the input/output flow specified by the backdoor specifying unit 114. As a result, it is possible to prevent spreading of a damage caused by the backdoor.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although a plurality of operations are described in order in the form of the flowchart, the order of description does not limit the order of executing the plurality of operations. Therefore, when each example embodiment is implemented, the order of the plurality of operations can be changed within a range that does not interfere in content.

In the first example embodiment, when an input/output flow that is not included in the regular input/output flow information exists in the operation input/output flow information, the backdoor determination unit 103 determines that a backdoor exists. The backdoor determination unit 103 may determine that there is a backdoor when an input/output flow that is not included in the acquired regular input/output flow information exists in the operation input/output flow information and there are many input/output flows that are not included in the regular input/output flow information as compared with the operation input/output flow information at a predetermined time point in the past. In this case, the operation flow acquisition unit 102 stores the operation input/output flow information at the predetermined time point in the past in the storage device 505, and acquires the operation input/output flow at the predetermined time point in the past from the storage device 505 when the backdoor detection is performed. Thus, the backdoor determination unit 103 determines that a backdoor exists at a time point when the propagation of the unauthorized function is checked as compared with the past operation input/output flow information. Therefore, it is possible to suppress an occurrence of a situation in which the alert signal is frequently output by the output unit 104.

### REFERENCE SIGNS LIST

100, 110 backdoor detection device
101, 111 regular flow acquisition unit
102, 112 operation flow acquisition unit
103, 113 backdoor determination unit
104, 115 output unit
114 backdoor specifying unit
116 control unit

What is claimed is:

1. A backdoor detection device comprising:
a memory storing instructions; and
at least one processor configured to execute the instructions to:
acquire regular input/output flow information including an input/output flow associated with an input/output observed by executing firmware of a device that is a monitoring target under a test environment;
acquire operation input/output flow information including an input/output flow associated with an input/output observed by executing the firmware under an actual operation environment;
to determine whether a backdoor exists based on a comparison between the acquired regular input/output flow information and the acquired operation input/output flow information; and
output a result of the determination.

2. The backdoor detection device according to claim 1, wherein the at least one processor is further configured to execute the instructions to:
determine that there is a backdoor when a predetermined number or more of input/output flows that are not included in the acquired regular input/output flow information exist in the acquired operation input/output flow information.

3. The backdoor detection device according to claim 1, wherein the at least one processor is further configured to execute the instructions to:
acquire operation input/output flow information at a predetermined time point in past, and
determine that there is a backdoor when an input/output flow that is not included in the acquired regular input/output flow information exists in the acquired operation input/output flow information and there are many input/output flows that are not included in the regular input/output flow information as compared with the operation input/output flow information at the predetermined time point in the past.

4. The backdoor detection device according to claim 1, wherein the at least one processor is further configured to execute the instructions to:
acquire, as the operation input/output flow information, an input/output flow observed by executing only a portion including a flow associated with an input/output of data in the firmware.

5. The backdoor detection device according to claim 1, wherein the at least one processor is further configured to execute the instructions to:
specify an input/output flow determined to be the backdoor, and
output input/output flow information determined to be the backdoor.

6. The backdoor detection device according to claim 5, wherein the at least one processor is further configured to execute the instructions to:
perform control in such a way as not to execute the specified input/output flow.

7. A backdoor detection method comprising:
acquiring regular input/output flow information including an input/output flow associated with an input/output observed by executing firmware of a device that is a monitoring target under a test environment;
acquiring operation input/output flow information including an input/output flow associated with an input/output observed by executing the firmware under an actual operation environment;
determining whether a backdoor exists based on a comparison between the acquired regular input/output flow information and the acquired operation input/output flow information; and
outputting a result of the determination.

8. A non-transitory computer readable recording medium storing a program for causing a computer to perform:
acquiring regular input/output flow information including an input/output flow associated with an input/output observed by executing firmware of a device that is a monitoring target under a test environment;
acquiring operation input/output flow information including an input/output flow associated with an input/output observed by executing the firmware under an actual operation environment;
determining whether a backdoor exists based on a comparison between the acquired regular input/output flow information and the acquired operation input/output flow information; and
outputting a result of the determination.
